(19) United States
(12) Patent Application Publication
(10) Pub. No.: US 2006/0272677 A1
(43) Pub. Date: Dec. 7, 2006

(54) Cleaning process for semiconductor substrates

(76) Inventors: Nam Pyo Lee, Eden Prairie, MN (US); Philip Clark, Eden Prairie, MN (US); Brent D. Schwab, Burnsville, MN (US)

Correspondence Address: KIMBERLY JORDAHL;Kagan Binder, PLLC, Maple Island Building, 221 Main Street North, Suite 200, Stillwater, MN, 55082, US

(21) Appl. No.: 11/156,763

(22) Filed: Jun. 20, 2005

Related U.S. Application Data
(60) Provisional application No. 60/584,699, filed on Jul. 1, 2004.

(51) Int. Cl. C23G 1/00; C23G 1/02; B08B 3/00

(52) U.S. Cl. 134/3; 134/2; 134/34; 134/26; 134/28; 134/29

(57) ABSTRACT

The present invention relates to cleaning processes for semiconductor substrates. More particularly, the present inventive method can provide enhanced particle removal efficiencies at a given material loss. In fact, in certain embodiments, the present method can achieve particle removal efficiencies of at least about 90%, while yet removing less than about 2 angstroms of any oxide present on the semiconductor substrate. As such, the present methods find particular applicability in the processing of advanced technology nodes.

### PRIORITY CLAIM

The present non-provisional patent Application claims priority under 35 USC §119(e) from United States Provisional Patent Applications having Ser. No. 60/584,699, filed on Jul. 1, 2004, entitled CLEANING PROCESS FOR SEMICONDUCTOR SUBSTRATES, wherein the entirety of said provisional patent application is incorporated herein by reference.

### FIELD

The present invention relates to cleaning processes for semiconductor substrates. More particularly, the present invention provides a particle removal process that can achieve particle removal efficiencies of up to about 90% or even greater, while yet removing less than about 2 angstroms of any oxide, or other material, such as Si, TEOS, SI₃N₄, etc. present on the semiconductor substrate. As such, the present methods find particular applicability in the processing of advanced technology nodes.

### BACKGROUND

Advanced technology nodes (65 nm and smaller) require unprecedented particle and material loss control to enable state-of-the-art device reliability and performance. Illustrative of the tightening of manufacturing tolerances in these nodes are the 2003 ITRS surface preparation requirements for FEOL processing through the 50 nm technology node, shown in FIG. 1. In particular, at the 65 nm node the material loss target for silicon and silicon oxide is less than 0.5 Å per cleaning step while minimizing particle adders (≧32.5 nm) to 80.

Even in light of these increasingly tight tolerances, very little has changed in surface preparation and cleaning chemistries since the introduction of the RCA clean in 1970. The RCA clean used for front-end-of-line (FEOL) clean processes comprises two immersion process steps known as standard clean 1 (SC-1) and standard clean 2 (SC-2) that may typically be applied in conjunction with megasonics, i.e., acoustic energy. While proven useful in larger technology nodes, the use of megasonic processes can result in pattern damage in the 0.25 μm technology node and smaller. Many semiconductor manufacturers thus ceased to use megasonics, at least in advanced technology node applications, or, adjusted manufacturing processes to increase the amount of substrate etching, thereby undercutting particles and facilitating the release thereof, as may be accomplished by applications of dHF in concentrations as low as about 0.5%. Unfortunately, even such low concentrations of dHF may typically remove at least about 3 nm of thermal oxide. See, e.g., R. Vos, “Removal of Submicrometer Particles from Silicon Wafer Surfaces using HF-Based Cleaning Mixtures,” J. Electrochem. Soc., 148, G683 (2001). For current state-of-the-art devices, e.g., those employing ultra-thin gate oxides, this amount of material loss may simply be too great.

One other conventional wafer cleaning sequence includes a sulfuric acid/hydrogen peroxide/deionized water (sulfuric peroxide mixture or SPM) to remove organics. The native silicon oxide is then etched from the wafer using a deionized water/hydrofluoric acid, typically at dilutions of at least about 100:1 water to 0.5% solids hydrofluoric acid. Particle and metal removal is then accomplished by ammonium hydroxide/hydrogen peroxide/deionized water (SC-1 or ammonium peroxide mixture or APM) and hydrochloric acid/hydrogen peroxide/deionized water (SC-2 or hydrochloric peroxide mixture or HPM). This four step process sequence for wafer cleaning applications is known as the “B Clean”. Such a multi-step process can be cost and/or time prohibitive in some applications. Additionally, and as shown by FIG. 2, it can be difficult to get acceptable particle removal efficiencies with minimal oxide loss using this conventional technology.

The conflicting requirements to decrease oxide/material loss while maintaining high particle removal efficiency for ever smaller particle sizes is thus currently one of the most difficult challenges in surface preparation and cleaning. Adding to already substantial technical challenges are the manufacturing limitations imposed by market requirements for shorter manufacturing cycle times to enable “supply-on-demand” manufacturing. Together, these technical and economic challenges have created a need for chemistries, and methods of using the same, which maintain high particle removal efficiencies with reduced material loss, pattern damage and cycle time.

### SUMMARY

The present invention provides such methods. More particularly, the present invention provides methods of removing particles from semiconductor substrates comprising exposing the substrate to an amount of dilute, preferably aqueous, hydrofluoric acid. Surprisingly, the hydrofluoric acid can provide particle removal efficiency of up to about 90%, or even higher, while not substantially damaging material, e.g., Si SiO₂, TEOS, Si₃N₄ and the like, present on the semiconductor substrate. This result is unexpected since hydrofluoric acid is known to preferentially etch oxide/material, and indeed, is utilized to do so in many semiconductor manufacturing processes.

The present invention thus provides a method for removing particles from a semiconductor substrate by exposing the substrate to an amount of dilute hydrofluoric acid. Desirably, the exposure to hydrofluoric acid will act to efficiently remove at least a portion of the particles, while not substantially damaging any oxide present on the semiconductor surface, i.e., while removing less than about 2 angstroms of any such oxide, or less than about 1 angstrom, or even less than about 0.5 angstroms of the oxide, and in some embodiments, removing as little as 0.2 or even 0.1 angstroms of the oxide. According to the present method, the dHF may be advantageously utilized alone, or, may be utilized in combination with one or more other cleaning processes, such as SC1 and/or SC2 cleaning processes. Furthermore, whether utilized alone or as one of a series of cleaning steps, the present method may be incorporated into wet or dry processes suitable for treating single, or multiple, substrates.

Although certain terms such as “substrate,” “microelectronic substrate,” “wafer,” and “semiconductor wafer” may be used interchangeably for purposes of describing the present invention, the present invention applies to cleaning microelectronic substrates generally.

### BRIEF DESCRIPTION OF THE DRAWINGS

FIG. 1 is a table showing a list of the 2003 ITRS surface node preparation requirements through the 50 nm technology node; and

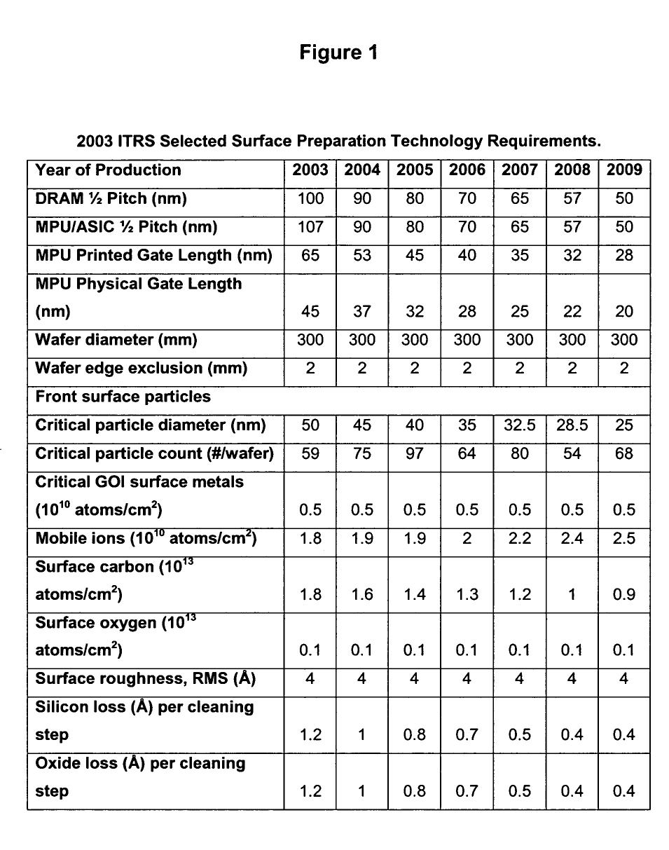

FIG. 2 is a graph illustrating particle removal efficiency versus oxide loss of an SPM SC-1 cleaning process on two types of challenge wafers.

### DETAILED DESCRIPTION

The embodiments of the present invention described below are not intended to be exhaustive or to limit the invention to the particular embodiments disclosed in the following detailed description. Rather, the embodiments are described so that others skilled in the art can understand the principles and practices of the present invention.

The method of the present invention provides efficient particle removal, while yet not increasing, and in some embodiment perhaps even lessening, oxide/material loss. It has now been discovered that exposure of a semiconductor substrate to an amount of dilute hydrofluoric acid can provide effective particle removal, while yet not substantially removing or otherwise damaging any material, e.g., Si, SiO₂, TEOS, Si₃N₄ etc., present on the substrate. More particularly, and surprisingly, exposure of semiconductor substrates to an amount of dHF, in concentrations at least about 5 times less than that commonly utilized in etching applications, can provide efficient particle removal, while removing less than about 2 angstroms of any such oxide, or less than about 1 angstrom, or even less than about 0.5 angstroms of the oxide, and in some embodiments, removing as little as 0.2 or even 0.1 angstroms of the oxide.

While not wishing to be bound by any theory, it is believed that, at the concentration utilized (which may be at least about 5 times less than that typically utilized in for etching, or other cleaning, applications), any particles present on the semiconductor substrate are more soluble to the dilute hydrofluoric acid than any oxide, or other material, such as Si, Si₃N₄, TEOS etc., present on the surface of the semiconductor substrate. As such, the application of dilute HF preferentially removes the particles, via chemical interaction therewith, rather than by etching the oxide/material out from underneath them.

This is an extremely surprising discovery, as the affinity of dHF for oxide over particulates has been replied upon in conventional semiconductor processing for years. That is, dHF has been conventionally utilized to underetch oxide/material out from under particulates, so that particulates may then be removed via a subsequent rinsing step. As such, these etching methods, even if referred to as cleaning steps, typically remove at least about 3 nm or more of oxide/material. See, e.g., R. Vos et al., Journal of Submicrometer Particles from Silicon Wafer Surfaces Using HF-Based Cleaning Mixtures, Journal of the Electrochemical Society, 148 (12), G683-G691 (2001), the entire disclosure of which is hereby incorporated by reference herein for any and all purposes. In advanced technology nodes, even this relatively small amount of oxide/material removal can be outside of manufacturing tolerances.

To the contrary, utilizing the method of the present invention, particle removal efficiencies of at least about 40%, up to about 60%, or even up to 90% in some embodiments, can be achieved with concurrent material losses of 2 angstroms or less, less than 1 angstrom, or less 0.5 angstroms, or in some embodiments, less than 0.2 or even 0.1 angstroms. More particularly, whereas conventional methods utilizing dHF to underetch particulates might use concentrations of e.g., 0.5% HF, the method of the present invention utilizes concentrations of less than about 0.1%, or less than 0.05% HF. Stated another way, the present invention uses aqueous HF at dilutions of at least about 1000:1 water to 49% solids HF (0.058 weight % HF), or even at least about 2000:1 water to 49% solids HF, or 0.029% by weight HF. It is believed that at such low concentrations the dHF disrupts the interaction between particles desirably removed from a semiconductor substrate and the substrate itself preferentially to etching material on the semiconductor substrate so that particulates can be removed with minimal material loss.

The present method may advantageously be applied alone in order to achieve the high particle removal efficiencies with minimal material loss described herein. However, in other embodiments of the invention, the method may be combined with one or more other cleaning processes, such as SC1 and/or SC2 cleaning processes. If such a combination is to be used, the order of performance of the steps is not critical, rather the combination of a dHF cleaning step with one or more other cleaning steps in any sequence or order is believed to be capable of delivering the enhanced particle removal at a given material loss described herein. For example, in certain embodiments of the invention, the dHF cleaning step may desirably be combined with all or a portion of a B-clean sequence, i.e., so that the sequences proceeds SPM-dHF-SC1, SPM-dHF-SC1-SC2, dHF-SPM-SC1, dHF-SPM-SC1-SC2, etc. Examples of particularly preferred embodiments of the present invention include cleaning sequences comprising the steps of SPM-dHF-SC1, dHF-SPM-SC1 or dHF-SC1-SPM.

In fact, the present method is so effective that, if utilized in combination with other cleaning processes, the protocol or chemistries of the additional processes may be lessened or otherwise modified to reduce any detrimental effects of the same. For example, in those embodiments of the invention wherein the dHF clean is incorporated into a B-clean sequence, the concentration and/or temperature of, e.g., the APM, may be reduced. More particularly, and in those embodiments of the invention where combining the dHF clean of the present invention with a B-clean may be desirable, the ammonium hydroxide/hydrogen peroxide/deionized water (APM) concentration may be reduced from the conventional 1:2:50 to 1:2:475 or even to 1:12:475. Alternatively, in these same embodiments, the temperature may be reduced from about 65° C. to about 25° C. Due to the incorporation of the dHF clean step according to the present invention, these modifications can provide cost and/or time savings, while the overall process may yet provide enhanced particle removal efficiencies with minimal material loss.

As another example, and although increasing H₂O₂ concentration within an APM mixture can lead to a reduction in silicon loss, this modification has been found to provide a silicon loss of 3 times the oxide loss. By utilizing a dHF cleaning step prior to such an APM step in accordance with the present invention, the expected silicon loss at a similar particle removal efficiency can be reduced to 2× the oxide loss.

Additionally, the incorporation of a dHF clean into a portion, or all, or a B-clean sequence, may allow the advantageous incorporation of megasonics without resulting in detrimental pattern damage. More particularly, the power applied to the megosonic generating device, e.g., piezoelectric transducers, may be lessened so that advantageous impact of utilizing the megasonics may be seen, without substantial pattern damage.

Similarly, the dHF solution itself can be utilized as simply as an aqueous solution of, e.g., 1000:1 water to 49% solids HF (0.058 weight % HF), or may further include amounts of any other additives commonly found in such cleaning solutions. Desirably, any such additives would at least minimally enhance the ability of the dHF to provide enhanced particle removal while minimizing material loss, but any additive conventionally utilized in semiconductor substrate cleaning solutions may be utilized, so long as the ability of the dHF to provide the inventive advantages described herein is not substantially detrimentally impacted.

For example, in certain embodiments, the aqueous dilute HF may comprise an amount of one or more surfactants. Conventional theory is that the use of such surfactants, and anionic surfactants in particular, can improve cleaning efficiencies by controlling the surface charge of the wafer and particle. The incorporation of an amount of a surfactant can be particularly beneficial when the substrate to be cleaned, or the particles to be removed, are positively charged, as the surfactant is believed to provide its beneficial impact by reversing the zeta potential of such positively charged surfaces and/or particles, thereby improving the electrostatic repulsion between the substrate and particles.

Furthermore, the method of the present invention may be incorporated into single wafer and batch wet or dry processes suitable for treating single, or multiple, substrates. Examples of wet processes into which the dHF cleaning step may be incorporated include, but are not limited to, spray processes, immersion processes, application of aerosols, etc. Examples of dry process include, but are not limited to exposure to ozone gas, plasma based photoresist stripping and polymer residue removal, laser induced defect removal and photochemical reactors. Similarly, the dilute dHF can be applied to the substrate to be cleaned in any suitable fashion, including, but not limited to, by spraying, e.g., of a liquid or aerosol, or by immersion.

Spray processors, such as any of those commercially available from FSI International, Inc. Chanhassen Minn., under the Zeta® tradename, are one type of capital equipment used in non-megasonic particle removal. The spray system utilizes centrifugal force for enhanced particle removal. Material loss control (±2% 1σ) is achieved via a reaction rate algorithm which inputs monitored values for chemical flow and temperature. The process chamber maintains a controlled nitrogen environment to minimize chemical degradation. Single wafer systems may also be utilized for particle removal processes, with appropriate modifications in light of the shortened process time.

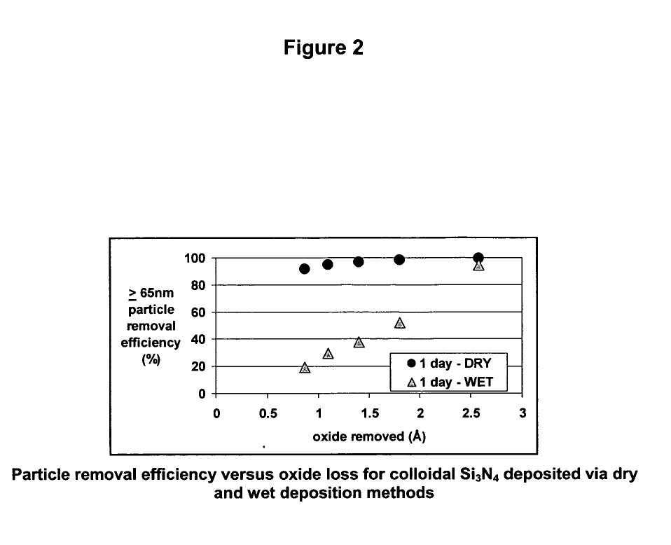

The invention is further illustrated in the examples that follow. As background for these examples, it is important to note that particle removal efficiency is dependent on challenge wafer preparation including method of particle deposition (wet-dipped or aerosol), particle composition and particle size distribution. At the present time, organizations which provide industry guidance (e.g., SEMI and ITRS) have not specified a guideline relating to particle removal challenge preparation. The impact of challenge wafer preparation can be further understood with reference back to FIG. 2, which illustrates the difference between particle removal efficiencies achieved using an SPM-APM process for two different particle removal challenge preparations. In particular, the “wet” particle challenge wafers were prepared by placing polycrystalline Si₃N₄ into an immersion bath containing silicon wafers. The “dry” particle challenge wafers were prepared using the same colloidal Si₃N₄ in a commercial aerosol deposition system (MSP). Both sets of wafers were then aged for 24 hours. As shown, higher particle removal efficiency versus oxide loss is observed for the dry deposited particles. Only 1 Å oxide loss was needed to remove >90% of the dry deposited Si₃N₄ particles as compared to the 2.5 Å needed to remove >90% of the wet deposited Si₃N₄ particles.

In the following examples, in which particle measurements were made via a KLA Tencor SP-1-TB-I Particle Measurement tool and oxide loss was measured with a Rudolph Caliber 300 Ellipsometer, wet deposited particle challenge wafers were utilized. Further, and in all instances, the concentration of sulfuric acid utilized was 96 weight %, the concentration of hydrogen peroxide utilized was 28 weight %, and the concentration of ammonium hydroxide utilized was from about 21 to about 72 weight % with about 10 to about 35 weight % ammonia.

Finally, and although the invention will be better understood by reference to the schemes and examples that follow, they should not be construed as limiting thereof. Rather, those skilled in the art will readily appreciate that these examples are only illustrative of the invention as described more fully in the claims that follow thereafter.

### COMPARATIVE EXAMPLE 1

A semiconductor substrate (wafer) is intentionally contaminated with colloidal silicon oxide in a dry deposition system yielding approximately 2000 particle adders with diameters greater than or equal to 120 nm.
1. The contaminated wafer is then loaded into a batch spray processor, for example, the FSI International, Inc., ZETA® Surface Cleaning System.
2. A solution containing sulfuric acid and hydrogen peroxide (SPM) was prepared in situ by combining flow rates of 800 cc/min sulfuric acid and 200 cc/min hydrogen peroxide and then dispensed onto the wafer for 240 seconds at a wafer rotation of 60 rpm.
3. The SPM mixture is then rinsed from the wafer using deionized water heated to 25° C. for about 160 seconds at wafer rotations of from about 20-300 rpm.
4. The SPM mixture is then rinsed using deionized water at ambient temperature for about 50 seconds at a wafer rotation of 60 rpm.
5. A solution containing ammonium hydroxide, hydrogen peroxide and deionized water heated to 30° C. (APM) was prepared in situ by combining flow rates of 20 cc/min ammonium hydroxide, 240 cc/min hydrogen peroxide and 9,750 cc/min deionized water and then dispensed onto the wafers for about 60 seconds at wafer rotations of from 120-300 rpm.
6. The APM mixture is then rinsed from the wafer using deionized water heated to 95° C. for about 120 seconds at wafer rotations of from about 60-300 rpm.
7. The APM mixture is then rinsed from the wafer using deionized water at ambient temperature for about 90 seconds at wafer rotations of from about 50-180 rpm.
8. The silicon wafer is then dried under a nitrogen purge for about 360 seconds at a wafer rotation of 300 rpm.
9. The wafer treated according to this embodiment of the present invention showed a 0.35 Å thermal silicon oxide loss and a 50% dry-deposited silicon oxide particle removal efficiency.

### EXAMPLE 1

A semiconductor substrate (wafer) is intentionally contaminated with colloidal silicon nitride in an immersion bath yielding 5,000-15,000 particle adders with diameters greater than or equal to 65 nm.
1. The contaminated wafer is then “aged” in a class 1 clean room environment for 24 hours.
2. The contaminated wafer is then loaded into a batch spray processor, for example, the FSI International, Inc., ZETA® Surface Cleaning System.
3. A solution containing sulfuric acid and hydrogen peroxide (SPM) is prepared by combining flow rates of 800 cc/min 96 wt % sulfuric acid and 200 cc/min 28 wt % hydrogen peroxide into a common flow stream and then dispensed onto the wafer for about 4 minutes at a wafer rotation of 60 rpm.
4. The SPM mixture is then rinsed from the wafer using deionized water heated to 55° C. for about 2.5 minutes at wafer rotations of from about 20-300 rpm. The SPM mixture is then further rinsed using deionized water at ambient temperature for about 3 minutes at a wafer rotation of 50 rpm.
5. A dilute HF solution (dHF) comprising 100:1 HF (100 parts water to 1 part 49 weight % hydrofluoric acid) and deionized water was prepared in situ by combining flow rates of 200 cc/min and 1,800 cc/min, respectively, (corresponding to a final solution concentration of 0.057 wt % HF) and then dispensed onto the wafers for about 0.5 minutes at a wafer rotation of 300 rpm.
6. The dHF mixture is then rinsed from the wafer using deionized water at ambient temperature for about 6 minutes at wafer rotations of from about 60-300 rpm.
7. A solution containing ammonium hydroxide, hydrogen peroxide and deionized water (APM) is then prepared by combining flow rates of each of 20 cc/min, 40 cc/min and 9,650 cc/min, respectively, is heated to 55° C. and then dispensed onto the wafers for about 3.5 minutes at wafer rotations of from about 60-300 rpm.
8. The APM mixture is then rinsed from the wafer using deionized water heated to 95° C. for about 2 minutes at wafer rotations of from about 60-300 rpm.
9. The APM mixture is then rinsed from the wafer using deionized water at ambient temperature for about 1.5 minutes at wafer rotations of from about 50-180 rpm.
10. The silicon wafer is then dried under a nitrogen purge for about 6 minutes at a wafer rotation of 300 rpm.
11. The wafer treated according to this embodiment of the present invention showed a 0.5 Å thermal silicon oxide loss and a 34% wet-dipped silicon nitride particle removal efficiency.

### EXAMPLE 2

A semiconductor substrate (wafer) is intentionally contaminated with colloidal silicon nitride in an immersion bath yielding 5,000-15,000 particle adders with diameters greater than or equal to 65 nm.
1. The contaminated wafer is then “aged” in a class 1 clean room environment for 24 hours.
2. The contaminated wafer is then loaded into a batch spray processor, for example, the FSI International, Inc., ZETA® Surface Cleaning System.
3. A solution containing sulfuric acid and hydrogen peroxide (SPM) was prepared in situ by combining flow rates of 800 cc/min sulfuric acid and 200 cc/min hydrogen peroxide, respectively, and then dispensed onto the wafer for about 4 minutes at a wafer rotation of 60 rpm.
4. The SPM mixture is then rinsed from the wafer using deionized water heated to 40° C. for about 2.5 minutes at wafer rotations of from about 20-300 rpm.
5. The SPM mixture is then rinsed from the wafer using deionized water at ambient temperature for about 1 minute at a wafer rotation of 200 rpm.
6. A dilute HF solution (dHF) comprising 100:1 HF (100 parts water to 1 part 49 wt % HF) and deionized water (dHF) was prepared in situ by combining flow rates of 1,000 cc/min HF and 10,000 cc/min deionized water, respectively, (corresponding to a final solution concentration of 0.052 wt % hydrofluoric acid) and then dispensed onto the wafers for about 1 minute at a wafer rotation of 200 rpm.
7. The dHF mixture is then rinsed from the wafer using deionized water at ambient temperature for about 1 minute at a wafer rotation of 200 rpm.
8. A solution containing ammonium hydroxide, hydrogen peroxide and deionized water heated to 40° C. (APM) was prepared in situ by combining flow rates of 20 cc/min ammonium hydroxide, 40 cc/min hydrogen peroxide and 9,750 cc/min deionized water, respectively, and then dispensed onto the wafers for about 6.5 minutes at wafer rotations of from about 60-300 rpm.
9. The APM mixture is then rinsed from the wafer using deionized water heated to 40° C. for about 4 minutes at wafer rotations of from about 60-300 rpm.
10. The APM mixture is then rinsed from the wafer using deionized water at ambient temperature for about 1.5 minutes at wafer rotations of from about 50-180 rpm.
11. The silicon wafer is then dried under a nitrogen purge for about 6 minutes at a wafer rotation of 300 rpm.
12. The wafer treated according to this embodiment of the present invention showed a 0.8 Å thermal silicon oxide loss and a 50% wet-dipped silicon nitride particle removal efficiency.

### EXAMPLE 3

1. A semiconductor substrate (wafer) is intentionally contaminated with colloidal silicon nitride in an immersion bath yielding 5,000-15,000 particle adders with diameters greater than or equal to 65 nm.
2. The contaminated wafer is then “aged” in a class 1 clean room environment for 24 hours.
3. The contaminated wafer is then loaded into a batch spray processor, for example, the FSI International, Inc., ZETA® Surface Cleaning System.
4. A solution containing sulfuric acid and hydrogen peroxide (SPM) was prepared in situ by combining flow rates of 800 cc/min sulfuric acid and 200 cc/min hydrogen peroxide and then dispensed onto the wafer for about 4 minutes at a wafer rotation of 60 rpm.
5. The SPM mixture is then rinsed from the wafer using deionized water heated to 50° C. for about 2.5 minutes at wafer rotations of from about 20-300 rpm.
6. The SPM mixture is then rinsed from the wafer using deionized water at ambient temperature for about 1 minute at a wafer rotation of 200 rpm.
7. A dilute HF solution (dHF) comprising 100:1 HF (100 parts water to 1 part 49 wt % HF) and deionized water was prepared in situ by combining flow rates of 1,000 cc/min HF and 10,000 cc/min deionized water (corresponding to a final solution concentration of 0.052 wt % hydrofluoric acid) and then dispensed onto the wafers for about 1 minute at a wafer rotation of 200 rpm.
8. The dHF mixture is then rinsed from the wafer using deionized water at ambient temperature for about 1 minute at a wafer rotation of 200 rpm.
9. A solution containing ammonium hydroxide, hydrogen peroxide and deionized water heated to 50° C. (APM) was prepared in situ by combining flow rates of 20 cc/min ammonium hydroxide, 40 cc/min hydrogen peroxide and 9,750 cc/min deionized water, respectively, and then dispensed onto the wafers for about 6.5 minutes at wafer rotations of from about 60-300 rpm.
10. The APM mixture is then rinsed from the wafer using deionized water heated to 50° C. for about 4 minutes at wafer rotations of from about 60-300 rpm.
11. The APM mixture is then rinsed from the wafer using deionized water at ambient temperature for about 1.5 minutes at wafer rotations of from about 50-180 rpm.
12. The silicon wafer is then dried under a nitrogen purge for about 6 minutes at a wafer rotation of 300 rpm.
13. The wafer treated according to this embodiment of the present invention showed a 1.2 Å thermal silicon oxide loss and a 71% wet-dipped silicon nitride particle removal efficiency.

### EXAMPLE 4

1. A semiconductor substrate (wafer) is intentionally contaminated with colloidal silicon nitride in an immersion bath yielding 5,000-15,000 particle adders with diameters greater than or equal to 65 nm.
2. The contaminated wafer is then “aged” in a class 1 clean room environment for 24 hours.
3. The contaminated wafer is then loaded into a batch spray processor, for example, the FSI International, Inc., ZETA® Surface Cleaning System.
4. A solution containing sulfuric acid and hydrogen peroxide (SPM) was prepared in situ by combining flow rates of 800 cc/min sulfuric acid and 200 cc/min hydrogen peroxide and then dispensed onto the wafer for about 4 minutes at a wafer rotation of 60 rpm.
5. The SPM mixture is then rinsed from the wafer using deionized water heated to 60° C. for about 2.5 minutes at wafer rotations of from about 20-300 rpm.
6. The SPM mixture is then rinsed using deionized water at ambient temperature for about 1 minute at a wafer rotation of 200 rpm.
7. A dilute HF solution (dHF) comprising of 100:1 HF (100 parts water to 1 part 49 wt % HF) and deionized water was prepared in situ by combining flow rates of 1,000 cc/min HF and 10,000 cc/min deionized water, respectively, (corresponding to a final solution concentration of 0.052 wt % hydrofluoric acid) and then dispensed onto the wafers for about 1 minute at a wafer rotation of 200 rpm.
8. The dHF mixture is then rinsed from the wafer using deionized water at ambient temperature for about 1 minute at a wafer rotation of 200 rpm.
9. A solution containing ammonium hydroxide, hydrogen peroxide and deionized water heated to 60° C. (APM) was prepared in situ by combining flow rates of 20 cc/min ammonium hydroxide, 40 cc/min hydrogen peroxide and 9,750 cc/min deionized water and then dispensed onto the wafers for about 6.5 minutes at wafer rotations of from 60-300 rpm.
10. The APM mixture is then rinsed from the wafer using deionized water heated to 60° C. for about 4 minutes at wafer rotations of from about 60-300 rpm.
11. The APM mixture is then rinsed from the wafer using deionized water at ambient temperature for about 1.5 minutes at wafer rotations of from about 50-180 rpm.
12. The silicon wafer is then dried under a nitrogen purge for about 6 minutes at a wafer rotation of 300 rpm.
13. The wafer treated according to this embodiment of the present invention showed a 1.7 Å thermal silicon oxide loss and a 94% wet-dipped silicon nitride particle removal efficiency.

### EXAMPLE 5

1. A semiconductor substrate (wafer) is intentionally contaminated with silicon oxide particles in a dry deposition system yielding approximately 2000 particle adders with diameters greater than or equal to 120 nm.
2. The contaminated wafer is then loaded into a batch spray processor, for example, the FSI International, Inc., ZETA® Surface Cleaning System.
3. A solution containing sulfuric acid and hydrogen peroxide (SPM) was prepared in situ by combining flow rates of 800 cc/min sulfuric acid and 200 cc/min hydrogen peroxide and then dispensed onto the wafer for 240 seconds at a wafer rotation of 60 rpm.
4. The SPM mixture is then rinsed from the wafer using deionized water heated to 25° C. for about 160 seconds at wafer rotations of from about 20-300 rpm.
5. The SPM mixture is then rinsed using deionized water at ambient temperature for about 30 seconds at a wafer rotation of 60 rpm.
6. A dilute HF solution (dHF) comprising 100:1 HF (100 parts water to 1 part 49 wt % HF) and deionized water was prepared in situ by combining flow rates of 11.9 cc/min HF and 12,000 cc/min deionized water, respectively, (corresponding to a final solution concentration of 0.057 wt % hydrofluoric acid) and then dispensed onto the wafers for about 40 seconds at a wafer rotation of 60 rpm.
7. The dHF mixture is then rinsed from the wafer using deionized water at ambient temperature for about 100 seconds at a wafer rotation of 60 rpm.
8. A solution containing ammonium hydroxide, hydrogen peroxide and deionized water heated to 25° C. (APM) was prepared in situ by combining flow rates of 20 cc/min ammonium hydroxide, 240 cc/min hydrogen peroxide and 9,750 cc/min deionized water and then dispensed onto the wafers for about 60 seconds at wafer rotations of from 120-300 rpm.
9. The APM mixture is then rinsed from the wafer using deionized water heated to 95° C. for about 120 seconds at wafer rotations of from about 60-300 rpm.
10. The APM mixture is then rinsed from the wafer using deionized water at ambient temperature for about 90 seconds at wafer rotations of from about 50-180 rpm.
11. The silicon wafer is then dried under a nitrogen purge for about 360 seconds at a wafer rotation of 300 rpm.
12. The wafer treated according to this embodiment of the present invention showed a 0.41 Å thermal silicon oxide loss and a 68% dry-deposited silicon oxide particle removal efficiency.

### EXAMPLE 6

1. A semiconductor substrate (wafer) is intentionally contaminated with colloidal silicon oxide in a dry deposition system yielding approximately 2000 particle adders with diameters greater than or equal to 120 nm.
2. The contaminated wafer is then loaded into a batch spray processor, for example, the FSI International, Inc., ZETA® Surface Cleaning System.
3. A solution containing sulfuric acid and hydrogen peroxide (SPM) was prepared in situ by combining flow rates of 800 cc/min sulfuric acid and 200 cc/min hydrogen peroxide and then dispensed onto the wafer for 240 seconds at a wafer rotation of 60 rpm.
4. The SPM mixture is then rinsed from the wafer using deionized water heated to 25° C. for about 160 seconds at wafer rotations of from about 20-300 rpm.
5. The SPM mixture is then rinsed using deionized water at ambient temperature for about 30 seconds at a wafer rotation of 60 rpm.
6. A dilute HF solution (dHF) comprising 100:1 HF (100 parts water to 1 part 49 wt % hydrofluoric acid HF) and deionized water was prepared in situ by combining flow rates of 5.9 cc/min HF and 12,000 cc/min deionized water, respectively, (corresponding to a final solution concentration of 0.028 wt % hydrofluoric acid) and then dispensed onto the wafers for about 40 seconds at a wafer rotation of 60 rpm.
7. The dHF mixture is then rinsed from the wafer using deionized water at ambient temperature for about 100 seconds at a wafer rotation of 60 rpm.
8. A solution containing ammonium hydroxide, hydrogen peroxide and deionized water heated to 30° C. (APM) was prepared in situ by combining flow rates of 20 cc/min ammonium hydroxide, 240 cc/min hydrogen peroxide and 9,750 cc/min deionized water and then dispensed onto the wafers for about 60 seconds at wafer rotations of from 120-300 rpm.
9. The APM mixture is then rinsed from the wafer using deionized water heated to 95° C. for about 120 seconds at wafer rotations of from about 60-300 rpm.
10. The APM mixture is then rinsed from the wafer using deionized water at ambient temperature for about 90 seconds at wafer rotations of from about 50-180 rpm.
11. The silicon wafer is then dried under a nitrogen purge for about 360 seconds at a wafer rotation of 300 rpm.
12. The wafer treated according to this embodiment of the present invention showed a 0.16 Å thermal silicon oxide loss and a 66% dry-deposited silicon oxide particle removal efficiency.

### EXAMPLE 7

1. A semiconductor substrate (wafer) is intentionally contaminated with colloidal silicon oxide in a dry deposition system yielding approximately 2000 particle adders with diameters greater than or equal to 120 nm.
2. The contaminated wafer is then loaded into a batch spray processor, for example, the FSI International, Inc., ZETA® Surface Cleaning System.
3. Wafers were rinsed using deionized water at ambient temperature for about 30 seconds at a wafer rotation of 60 rpm.
4. A dilute HF solution (dHF) comprising 100:1 HF (100 parts to 1 part 49 wt % HF) and deionized water was prepared in situ by combining flow rates of 5.9 cc/min HF and 12,000 cc/min deionized water, respectively, (corresponding to a final solution concentration of 0.028 wt % hydrofluoric acid) and then dispensed onto the wafers for about 40 seconds at a wafer rotation of 60 rpm.
5. The dHF mixture is then rinsed from the wafer using deionized water at ambient temperature for about 100 seconds at a wafer rotation of 60 rpm.
6. A solution containing ammonium hydroxide, hydrogen peroxide and deionized water at ambient temperature (APM) was prepared in situ by combining flow rates of 20 cc/min ammonium hydroxide, 240 cc/min hydrogen peroxide and 11,750 cc/min deionized water and then dispensed onto the wafers for about 60 seconds at a wafer rotation of 120 rpm.
7. The APM mixture is then rinsed from the wafer using deionized water at ambient temperature for about 60 seconds at wafer rotations of from about 60-300 rpm.
8. The APM mixture is then rinsed from the wafer using deionized water heated to 25° C. for about 60 seconds at wafer rotations of from about 20-60 rpm.
9. A solution containing sulfuric acid and hydrogen peroxide (SPM) was prepared in situ by combining flow rates of 800 cc/min sulfuric acid and 200 cc/min hydrogen peroxide and then dispensed onto the wafer for 240 seconds at a wafer rotation of 60 rpm.
10. The SPM mixture is then rinsed from the wafer using deionized water heated to 25° C. for about 160 seconds at wafer rotations of from about 20-300 rpm.
11. The SPM mixture is then rinsed using deionized water at ambient temperature for about 50 seconds at a wafer rotation of 60 rpm.
12. A solution containing ammonium hydroxide, hydrogen peroxide and deionized water at ambient temperature (APM) was prepared in situ by combining flow rates of 120 cc/min ammonium hydroxide, 240 cc/min hydrogen peroxide and 12,000 cc/min deionized water and then dispensed onto the wafers for about 60 seconds at wafer rotations of from 120-300 rpm.
13. The APM mixture is then rinsed from the wafer using deionized water heated to 95° C. for about 120 seconds at wafer rotations of from about 60-300 rpm, and then by using deionized water at ambient temperature for about 90 seconds at wafer rotations of from about 50-180 rpm.
14. The silicon wafer is then dried under a nitrogen purge for about 360 seconds at a wafer rotation of 300 rpm.
15. The wafer treated according to this embodiment of the present invention showed a 0.37 Å thermal silicon oxide loss and a 78% dry-deposited silicon oxide particle removal efficiency.

### EXAMPLE 8

A semiconductor substrate (wafer) will be intentionally contaminated with colloidal silicon oxide in a dry deposition system yielding approximately 2000 particle adders with diameters greater than or equal to 120 nm.
1. The contaminated wafer will then be loaded into a batch spray processor, for example, the FSI International, Inc., ZETA® Surface Cleaning System.
2. The wafer will be rinsed using deionized water at ambient temperature for about 30 seconds at a wafer rotation of 60 rpm.
3. A dilute HF solution (dHF) comprising 100:1 HF (100 parts to 1 part 49 wt % HF) and deionized water will be prepared in situ by combining flow rates of 5.9 cc/min HF and 12,000 cc/min deionized water, respectively, (corresponding to a final solution concentration of 0.028 wt % hydrofluoric acid) and will then be dispensed onto the wafers for about 40 seconds at a wafer rotation of 60 rpm.
4. The dHF mixture will then be rinsed from the wafer using deionized water at ambient temperature for about 100 seconds and at a wafer rotation of 60 rpm.
5. A solution containing sulfuric acid and hydrogen peroxide (SPM) will be prepared in situ by combining flow rates of 800 cc/min sulfuric acid and 200 cc/min hydrogen peroxide and then dispensed onto the wafer for 240 seconds at a wafer rotation of 60 rpm.
6. The SPM mixture will then be rinsed from the wafer using deionized water heated to 25° C. for about 160 seconds at wafer rotations of from about 20-300 rpm, followed by a rinse using deionized water at ambient temperature for about 50 seconds at a wafer rotation of 60 rpm.
7. A solution containing ammonium hydroxide, hydrogen peroxide and deionized water at ambient temperature (APM) will be prepared in situ by combining flow rates of 120 cc/min ammonium hydroxide, 240 cc/min hydrogen peroxide and 12,000 cc/min deionized water and then dispensed onto the wafers for about 60 seconds at wafer rotations of from 120-300 rpm.
8. The APM mixture will then be rinsed from the wafer using deionized water heated between ambient and 95° C. for about 210 seconds at wafer rotations of from about 60-300 rpm.
9. The silicon wafer will then be dried under a nitrogen purge for about 360 seconds at a wafer rotation of 300 rpm.
10. The wafer treated according to this embodiment of the present invention is expected to show <0.5 Å thermal silicon oxide loss and >70% dry-deposited silicon oxide particle removal efficiency.

While the foregoing specification teaches the principles of the present invention, with examples provided for the purpose of illustration, it will be understood that the practice of the invention encompasses all of the usual variations, adaptations and/or modifications as come within the scope of the following claims and their equivalents.

What is claimed is:

1. A method for removing particles from an oxide containing semiconductor substrate comprising exposing the substrate to an amount of dilute aqueous hydrofluoric acid under conditions such that at least about 90% of the particles are removed while less than about 2 angstroms of the oxide is removed.

2. The method of claim 1, wherein the dilute aqueous hydrofluoric acid has a concentration of from about 1000 parts H₂O to about 1 part 49% by weight HF.

3. The method of claim 1, wherein the dilute aqueous hydrofluoric acid has a concentration of from about 2000 parts H₂O to about 1 part 49% by weight HF.

4. The method of claim 1, wherein the step of exposing the substrate to the dilute hydrofluoric acid acts to remove less than about 1 angstrom of the oxide.

5. The method of claim 4, wherein the step of exposing the substrate to the dilute hydrofluoric acid acts to remove less than about 0.5 angstroms of the oxide.

6. The method of claim 5, wherein the step of exposing the substrate to the dilute hydrofluoric acid acts to remove less than about 0.2 angstroms of the oxide.

7. The method of claim 1, wherein the particle removal step comprises a portion of a post-ash cleaning process.

8. The method of claim 7, wherein the post-ash cleaning process comprises a wet process.

9. The method of claim 8, wherein the process comprises spraying a treatment liquid onto the substrate.

10. The method of claim 8, wherein the process comprises immersing at least a portion of the substrate into a treatment liquid.

11. The method of claim 10, wherein at least a portion of the immersing step occurs in the presence of acoustic energy.

12. The method of claim 9, wherein the process comprises applying an aerosol to at least a portion of the substrate.

13. The method of claim 7, wherein the post-ash cleaning process is a dry process.

14. The method of claim 13, wherein the post-ash cleaning process applying an amount of ozone gas to at least a portion of the substrate.

15. A method of removing particles from a semiconductor substrate comprising:
providing a substrate comprising particles to be removed;
causing a first cleaning liquid to contact the substrate, said first cleaning liquid comprising an acid and an oxidant;
causing a second cleaning liquid to contact the substrate under conditions such that the second liquid is substantially non-etching, said second cleaning liquid comprising dilute aqueous hydrofluoric acid;
causing a third cleaning liquid to contact the substrate, said third liquid comprising aqueous ammonia and an oxidant.

16. A method of removing particles from a semiconductor substrate comprising:
providing a substrate comprising particles to be removed;
causing a first cleaning liquid to contact the substrate under conditions such that the first liquid is substantially non-etching, said first cleaning liquid comprising dilute aqueous hydrofluoric acid;
causing a second cleaning liquid to contact the substrate, said second cleaning liquid comprising an acid and an oxidant;
causing a third cleaning liquid to contact the substrate, said third liquid comprising aqueous ammonia and an oxidant.

17. The method of claim 16, wherein the third cleaning liquid comprises an ammonium peroxide mixture.

18. The method of claim 17, wherein the concentration ratio of the ammonium hydroxide/hydrogen peroxide/deionized water is about 1:2:475.

19. The method of claim 18, wherein the concentration ratio of the ammonium hydroxide/hydrogen peroxide/deionized water is about 1:12:475.

20. The method of claim 16, wherein at least a portion of the steps are carried out at a temperature of less than about 25° C.
